(19) United States
(12) Patent Application Publication
(10) Pub. No.: US 2022/0088642 A1
(43) Pub. Date: Mar. 24, 2022

(54) Edge-a-Squeege

(71) Applicant: Christina Anne Angell, Lafayette, CA (US)

(72) Inventor: Christina Anne Angell, Lafayette, CA (US)

(21) Appl. No.: 17/030,377

(22) Filed: Sep. 24, 2020

(51) Int. Cl. B08B 1/00

(52) U.S. Cl. CPC B08B 1/005

(57) ABSTRACT

An innovative improvement of the hand-held squeegee. A curved squeegee, allowing cleaning in the crevasses of acute, obtuse, or right angles as well as flat surfaces. Uses could include household deep cleaning, animal troughs, cylinders, buckets, boats, industrial vats with solvents, glass tanks and more. Created by an avid equestrian who was sick of scrubbing the disgusting algae out of her horse's water trough. This tool is no-touch way to clean edges of surfaces. Allows the user to utilize the tool in situations where edge and crevasse cleaning or scraping is desired especially if toxic, chemical, bacteria laden, moldy, or dirty material is present.

This is a tool used to scape and clean angles as well as flat surfaces. It features a rubber or silicon blade held in place with a metal or plastic channel. It features a handle which can attach to a pole. It can be fashioned with varying degrees (acute, obtuse, or right angles) such as, but not limited to a 90° angel to clean and scape surfaces. This tool allows cleaning in the crevasses of angles as well as flat surfaces. It can be used for multiple purposes, such as household cleaning, animal troughs, industrial vats, glass, tanks, boats.

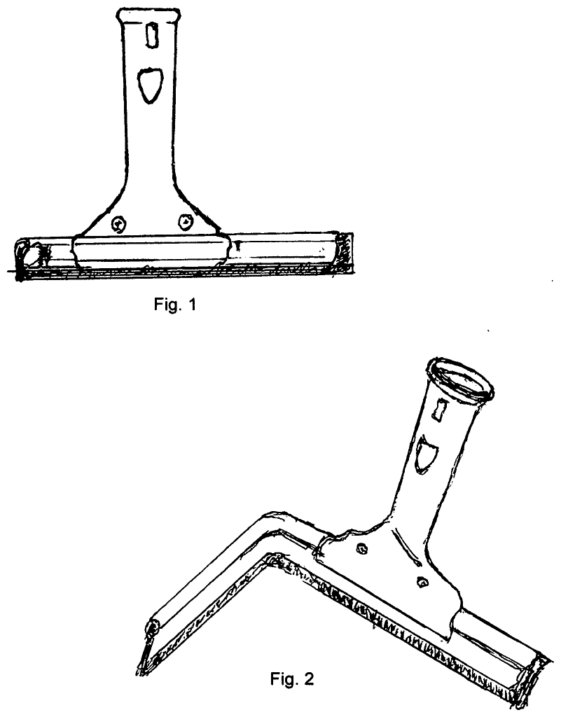

FIG. 1 is a rear view of the tool, with the handle at the top and the rubber or silicon blade on the bottom. FIG. 2 is front view showing the angel of the took, with the handle at the top of the drawing and the rubber or silicon blade at the bottom.

1. A tool comprising:
a rubber or silicone blade;
secured by a metal or plastic channel;
with a handle;
angled to fit into acute, obtuse, or right angles.
